(19) United States
(12) Patent Application Publication
(10) Pub. No.: US 2023/0219046 A1
(43) Pub. Date: Jul. 13, 2023

(54) APPARATUS FOR SUPPLYING OR DISSIPATING HEAT, FOR CARRYING OUT REACTIONS AND FOR MIXING AND DISPERSING FLOWING MEDIA

(71) Applicant: SULZER MANAGEMENT AG, Winterthur (CH)

(72) Inventor: Felix STREIFF, Humlikon (CH)

(21) Appl. No.: 18/021,169

(22) PCT Filed: Aug. 11, 2021
(86) PCT No.: PCT/CH2021/050018

§ 371 Date: Feb. 13, 2023

(30) Foreign Application Priority Data
Aug. 14, 2020 (CH) 01018/20

(51) Int. Cl. B01F 25/431; B01F 25/421; B01F 35/93; F28D 7/16; F28F 1/38; F28F 9/013; F28F 9/22; F28F 9/24

(52) U.S. Cl. CPC B01F 25/43161; B01F 25/4231; B01F 35/93; F28D 7/16; F28F 1/38; F28F 9/0132; F28F 9/22; F28F 9/24; F28D 2021/0052

(57) ABSTRACT

An apparatus for supplying and dissipating heat, for carrying out reactions and for mixing and dispersing flowing media in a housing with an internal diameter for a medium and comprising internal fittings made up of a bundle of tubes with an external diameter or made up of other elongate elements oriented parallel to the longitudinal axis of the housing is provided. The apparatus includes crosspieces or crosspiece layers installed crosswise between the elongate elements. The crosspieces are inclined in relation to the longitudinal axis of the housing and are not in contact. After axially successive crosspieces, or a length, the crosspieces are installed between the tubes and turned by preferably 90°. A heat-transfer medium can flow in a co-current or counter-current mode. This results in a mixer/heat exchanger or reactor with an extremely large heat-transfer capacity and almost plug flow.

### CROSS-REFERENCE TO RELATED APPLICATION

This application is a U.S. national Stage application of International Application No. PCT/CH2021/050018, filed Aug. 11, 2021, which claims priority to Swiss Application No. 01018/20, filed Aug. 14, 2020, the contents of each of which are hereby incorporated by reference.

### FIELD OF THE INVENTION

The disclosure relates to an apparatus for supplying or dissipating heat, for carrying out reactions and for mixing and dispersing flowing media in a housing with installations according to the preamble of claim 1. The apparatus consists of a bundle of tubes or other elongated elements with an orientation preferably parallel to the longitudinal axis of the housing, or tube bundle and, inserted between the tubes or the elongated elements, bars or layers of bar of a first arrangement which are inclined towards the longitudinal axis of the housing and at least one second arrangement of layers of bar, wherein the angle of inclination of the bars of the first arrangement has an opposite sign to the arrangement of the second layers of bar and are crossing but do not touch each other. The bars are installed between the tubes of the tube bundle and do not touch each other. A tube or row of tubes is preferably located between the crossing bars of the first arrangement and the second arrangement. The flowing medium (product) flows in the axial main direction of flow around the tubes in the housing. Due to the crosswise arranged bars inclined with respect to the tubes or with respect to the housing axis, the flowing medium is forced to flow crosswise around the tubes and is constantly cross-mixed at the same time. A heat transfer medium can flow in the tubes in co-current or counter-current to the product, but does not have to flow that way. The housing is preferably a round tube or the casing space of a tube bundle heat exchanger. The apparatus according to the disclosure is preferably suitable for laminar flowing media, but can also be used with turbulent flow. The disclosure further relates to a process for carrying out heterogeneous catalytic reactions or mass transfer in a flowing medium in an apparatus according to the disclosure.

### BACKGROUND OF THE INVENTION

From the patent specification CH 642 564, a very efficient static mixing apparatus for laminar flow with highly viscous products is known, in which the mixing elements consist of groups of 6-10 crossing bars in relation to the projection of the cross-section, which are arranged in crossing planes. The bars or planes are preferably inclined at 45° with respect to the direction of flow and the adjacent bars touch at the crossing points. The mixing elements have a length of 0.75 to 1.5 D and successive mixing elements are built into the housing rotated by 90°. Especially for the improvement of heat transfer in laminar flow tubes, a stretched version with crossing bars inclined only 30° to the direction of flow, which has a lower pressure loss coefficient, but also a lower mixing and heat exchange effect, is known, as described in CH 627 263. These mixing elements are still used today, with slight variations, by many suppliers as so-called X-mixers (e.g., SMX, SMXL, KMX, GX, CSE-X, AMX or UM. The list is not complete). They are characterised by a very good mixing effect, high heat transfer or Nu-number (Nu=αD/λ) and a very narrow residence time spectrum. Here, the heat transfer coefficient on the product side, D (or also d) mean α the tube diameter and λ the thermal conductivity of the product. Furthermore, the Nu-number is independent of the tube length, even in laminar flow, because of the constant cross-mixing and renewal of the boundary layer, in contrast to the empty tube. The heat transfer coefficient α is increased by a factor of 5-10 in laminar flow compared to the empty tube. The usual heat transfer coefficients k for highly viscous substances with these apparatuses are in the range of 150-250 W/(m²K). Static mixers with an X-structure have the narrowest residence time spectrum among all known static mixers. The measured Bodenstein number Bo is 50-100 m⁻¹ or e.g., up to 200 for a reactor of 2 m length (F. Streiff in Wärmeübertragung bei der Kunststoffaufbereitung, p. 241/275. VDI-Verlag, Düsseldorf 1986). In this way, practically an ideal plug flow is achieved (Bo=∞). The Bodenstein number is a standard, dimensionless measure for the width of the residence time distribution or the axial backmixing according to the dispersion model (Bo=vL/Dₐₓ). Here, v represents the mean axial flow velocity. Dₐₓ represents the axial dispersion coefficient, and L is the axial length of the apparatus. Compared with the residence time spectrum of the cascade model of a number j of stirred tanks connected in series, Bo=2j. The residence time behaviour of such a reactor with Bo=200 is therefore comparable to a cascade of 100 ideal stirred tanks. Many applications for static mixers require intensive cross-mixing, a large heat transfer capacity and a narrow residence time spectrum at the same time. Examples are reactors, especially with laminar flow such as polymerisation reactors. In other applications, products must be heated or cooled in a short time without undesirable occurrence of reactions and product changes (polymerisation, degradation). In the empty tube, there is no cross-flow to the wall in laminar flow. This has a very unfavourable effect on the heat transfer, the residence time distribution and the quality of the products. In some applications, the flowing medium is additionally 2-phase (gas/liquid) and the apparatus is intended to cause intensive mixing of the phases and dispersion in addition to heat exchange. Examples are the heating of polymer solutions with volatile components or the cooling of plastic melts with blowing agents. An X-mixer in a housing that is heated or cooled from the outside is the ideal solution for all of these tasks with low throughputs. However, scale-up becomes impossible at industrial throughputs because the ratio of surface area to volume in a tube with a larger diameter decreases very quickly and the heat can no longer be transferred sufficiently. One possible solution to this problem is to connect many tubes in parallel in a tube bundle heat exchanger and to install mixing elements in the tubes. Thereby, the favourable properties of the mixers are preserved but unfortunately only in one tube. Very large differences in flow rate and residence time can occur from one tube to the other. This is a particularly high risk if viscous products are to be cooled or if polymer solutions react and at least partially degas in the heat exchanger at the same time. Different temperatures and viscosities in the individual tubes result in so-called maldistribution. The maldistribution leads to a glaring inequality of flow velocity, temperature and viscosity in the individual tubes. The result can be a failure of the apparatus or a reduction in product quality.

Due to the relatively high pressure loss coefficient of the X-mixing elements, the shell-and-tube heat exchangers must be built with many short tubes. This makes them very expensive in addition to the cost of the installation elements because the tube plates become thick and the volume of the heads becomes very large. In product heaters with partial degassing, the pressure loss of the mixing elements prevents premature partial degassing and the product is thus damaged or complete degassing is hindered. Another disadvantage of the X-structure is its mechanical weakness for absorbing the flow forces. Particularly when subjected to tension, they behave like a slidable lattice grate and are easily pulled apart. But even when loaded in compression, they behave like a spring and are not very stable. As a result, the bars have to be made very thick for high-viscosity products. This leads to a further strong increase in pressure loss. Reinforcing elements or outer rings are used to try to make the structure more stable.

Patent specification DE 28 39 564 proposes a static mixer heat exchanger or reactor which adopts the basic idea of the X-structure but replaces the bars with tubes in which a heating or cooling medium flows. In this way, a solution was found to keep the specific heat exchange area per volume comparable to that of a small housing diameter during scale-up and, at the same time, to obtain a similar mixing effect and a similar residence time behaviour as an X-mixer. The structure is formed from crossing, meandering bent tube coils. The tubes are also preferably inclined at 45° with respect to the direction of flow and take over the function of the bars. A number of such crossing snakes each form a mixing element and successive elements are installed in a housing rotated by 90°. Each element must be equipped with its own collector for the heat transfer medium. The design and construction of these devices is very demanding and expensive. In order to keep the effort within limits, the element length is chosen as long as possible, which of course has an unfavourable influence on the mixing effect due to the low number of 90° turns. The pressure loss on the product side as well as on the heat transfer medium side is very high. The flow rate in the individual tube coils can be very uneven. The problem is especially big if the housing is circular for practical reasons, instead of square as originally intended. This leads to the risk of additional maldistribution on the product side. By choosing the diameter and the number of tube coils, very large reactor volumes with a large ratio of heat exchange surface A to volume V or with a high specific heat transfer capacity (\dot{Q}/vΔT)=(kA/V)>10 KW/m³K can be realised independently of the reactor volume (cf. p. 265 of the reference cited above). In the formulas, \dot{Q} refers to the transferable heat flow, ΔT refers to the mean temperature difference between the product and the heat transfer medium, and k refers to the heat transfer coefficient. This simplifies scale-up and eliminates the need to use parallel tubes. Thus, the risk of maldistribution is reduced. However, the utilization of the volume with the heat exchange surface is limited by the smallest possible bending radius of the tube coils and the pressure loss. In this device, too, the residence time distribution is as narrow as in the X-mixer. Again, measured Bodenstein numbers are approx. 60 m⁻¹. However, the homogenization length for laminar mixing is up to twice as long as with the SMX-mixer because of the round shape of the bars and because of the long elements (W. Müller. Chem.-Ing. Tech. 54 1982, No. 6). The structure cannot be used for highly viscous products without additional support elements because it is not sufficiently stable. According to US2004/0125691, the stability is improved with additional elongated support elements, but it remains a weak point and is expensive. Despite the shortcomings and troubles, the devices have stood the test of time and are known as SMR reactors and are often used as polymerisation reactors or coolers for viscous products, e.g., in fibre plants or for cooling plastic melts.

Patent specification EP1 067 352 proposes another static mixer heat exchanger or reactor with crossing bars of the X-structure with an integrated tube bundle. The X-structure has only 4 bars in relation to the projection of the cross-section and the tubes are guided through holes in the bars, which are inclined at 45° to the direction of flow. The bars lie in crossing groups of planes which enclose an angle of 90° with each other. The bars touch and are connected to each other and at least partially to the tubes. The X-structure of 4 bars across the cross-section is built up first and the tubes are fed through the holes in the bars of the finished structure. The axial bar spacing should be 0.2-0.4 D. A modification of this structure is presented in patent specification WO 2008/141472, in which the axial distance between the bars and the diameter of the inner tubes should be <6. As a result, an improvement in heat transfer is achieved. By choosing the diameter and the number of tubes, a very large reactor volume with a high ratio of heat exchange surface to volume, or with a high specific heat transfer capacity as in the SMR, can be realised. The pressure loss on the heat transfer medium side is significantly lower than with the SMR and there are no mechanical limits due to the bending radius. According to the patent specification, the residence time behaviour of this structure is also very good and comparable with the X-mixers. However, the construction is very complex and requires a very high level of precision. It is difficult to align all the holes in the mixer and in the tube plate without excessive tolerances. Mechanical strength remains a problem, as with the X-structure.

### SUMMARY

The object of the disclosure is to provide an apparatus for supplying or dissipating heat, for carrying out reactions or also as a reactor for photosynthesis and for mixing and dispersing flowing, liquid, gaseous or multiphase media in a tube-like housing without maldistribution and with a narrow residence time distribution, preferably for viscous products, with an X-structure, which is much simpler and cheaper to manufacture than previously known apparatuses with this structure and which, if required, also has a high stability against the flow forces and a lower pressure loss, both as heat transfer medium and as the product. The object is achieved by the features of claim 1. Particularly advantageous embodiments are the subject matter of the dependent claims.

Another aspect of the present disclosure is the subject of independent method claim 20.

The “spacing t” or the “tube spacing t” is understood to mean in particular the distance between the tube centres of two adjacent tubes in a tube row transverse to the tube or housing axis or the distance between the centres of two adjacent elongated elements in a row transverse to the axis of the elongated elements or housing axis.

“Square spacing” means in particular that the distances from adjacent tube centres are equal in a first direction transverse to the tube or housing axis and in a second direction transverse to the tube or housing axis, wherein the second direction is perpendicular to the first direction. The same applies analogously to elongated elements. This square spacing is shown and described, for example, in the VDI Heat Atlas, 6th edition, 1991, Section Ob6, Picture 9.

### BRIEF DESCRIPTION OF THE DRAWINGS

The disclosure will be explained in more detail hereinafter with reference to the drawings.

FIG. 1 shows a side view of a part of an embodiment variant of an apparatus according to the disclosure with 9 tubes and with 4 crossing bars in relation to the projection of the cross-section in a cut open housing.

FIG. 2 shows a projection in the direction of flow of a cross-section through an embodiment variant of an apparatus according to the disclosure with 9 tubes and 4 layers of bars in the projection of the cross-section. The bars have the maximum width b=t−d and fit between the tubes.

FIG. 3 shows a projection in direction of flow of a cross-section through an embodiment variant of an apparatus according to the disclosure with 21 tubes or rods and 6 bars in the projection of the cross-section, wherein the maximum width of the bars in the area of the tubes are b=t−d and even decreasing in between. The bars fit between the tubes.

FIG. 4 shows a projection in direction of flow of a cross-section through an embodiment variant of an apparatus according to the disclosure with 16 tubes and 5 bars in the projection of the cross-section, wherein the width of the bars have cut-outs in the area of the tubes, and the bar width b is smaller than the tube spacing but greater than is the space between adjacent tubes. There are no tubes in the axes of the cross-sections. This arrangement allows U-shaped tube loops.

FIG. 5 shows a projection in the direction of flow of a cross-section through an embodiment variant of an apparatus according to the disclosure with 32 tubes and 7 layers of bars in the projection of the cross-section.

FIG. 6 shows the projection in the direction of flow of a cross-section through an embodiment variant of an apparatus according to the disclosure as in FIG. 5 with only partially used spaces for the tubes or elongate elements.

FIG. 7 shows a projection in the direction of flow of a cross-section through an embodiment of an apparatus according to the disclosure with 45 tubes and 8 layers of bars in the projection of the cross-section, wherein the sign of the inclination of the bars are the same for 2 adjacent layers of bars (indicated by hatching) and changes in groups.

FIG. 8 shows the projection in the direction of flow of a cross-section through an embodiment variant of an apparatus according to the disclosure, with interwoven bars as 90°-rotated crosses.

FIG. 9 shows a perspective representation of an embodiment variant of an apparatus according to the disclosure with bars (31a, 41b) partially cut to the length L of the mixing elements. The bars have a maximum width b>(t−d) and partially enclose the tubes.

FIG. 10 shows a perspective representation of a further embodiment variant of an apparatus according to the disclosure, in which the bars are at least partially displaced in relation to each other in the longitudinal direction and the mixing elements have axial distances.

FIG. 11 shows a perspective representation of a further embodiment variant of an apparatus according to the disclosure, in which the bars are interwoven as 90°-rotated crosses according to FIG. 8.

FIG. 12 shows a representation of further possible shapes and cross-sections for bars and elongate elements or tubes. The representation is not limited.

FIG. 13 shows a perspective view of a possible grid-like connection of bars to a layer of bars by support rods.

FIG. 14 shows a perspective view of a possible variant of a layer of bars made of inclined bars which are connected to form a corrugated sheet-like laver of bars.

FIG. 15 shows the result of a mixing trial with a structure according to the disclosure according to FIG. 9 (RWX) in comparison to a static mixer according to CH642 564 with 8 bars in the projection of the cross-section.

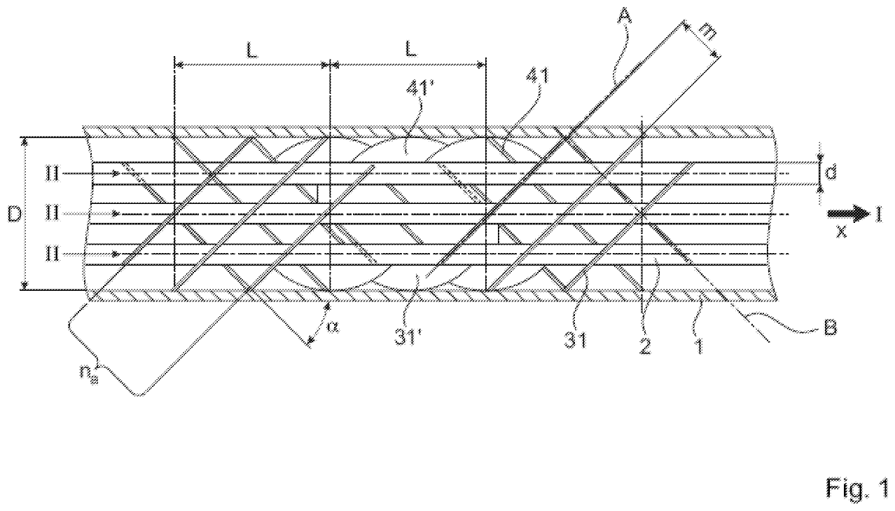

### DETAILED DESCRIPTION

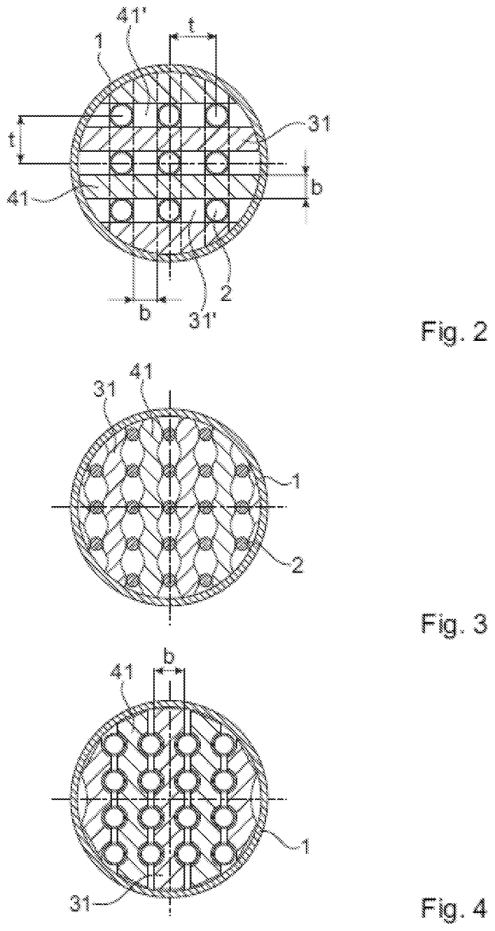

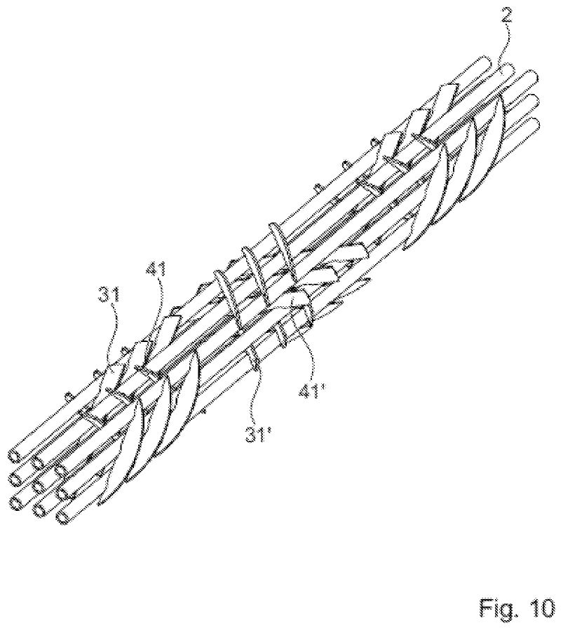

According to the idea of the disclosure, the apparatus consists of a preferably circular housing 1 with an inside diameter D and a built-in tube bundle with tubes 2 parallel to the longitudinal axis and to the main direction of flow and having an outside diameter d. Other elongated elements can also take the place of the tubes. The tube bundle preferably has a square tube spacing t. Between the tubes, bars (31,41) or layers of bars are installed inclined at an angle α, preferably α=30-60°, more preferably α=45° to the longitudinal axis. The angle of inclination of the crossing bars (31,41) preferably has an opposite sign and the bars following each other in the axial direction of a layer of bars between the tubes are preferably parallel to each other, all preferably having the same distance m. There is preferably a tube or a row of tubes between the crossing bars, but it is also possible that the angle of inclination of the bars has the same sign on both sides of a tube or a row of tubes, and that the change of sign only occurs after several adjacent bars or layers of bars done. The bars of the layers of bars preferably lie one behind the other in the transverse direction in parallel, intersecting planes A, B with the angle of inclination α with respect to the longitudinal axis. All bars preferably have the same angle of inclination α. However, it is also possible for the bars or layers of bars to be offset axially as desired and/or for the vertical distances m of the bars or also the angle of inclination to differ within one layer of bars or from one layer of bars to the next. Thus, the bars lie in the transverse direction, no longer in common planes one behind the other. The bars have a width b and this width is less than or at most equal to the tube spacing t. The bars are preferably perpendicular to the tubes with their width b. However, it is also possible to install the bars with their width inclined towards the tubes. The bars can, but do not have to, reach all the way to the housing wall or they can also only touch it at certain points. The flowing medium (I) or the product flows in the housing or in the casing space of the tube bundle around the tubes or elongated elements and in the tubes a heat transfer medium (II) can flow in co-current or counter-current, but does not have to flow that way. In each case a number nₐ of bars following each other in the axial direction form a layer of bars and all layers of bars in a cross-section within the length L form a mixing element. The layers of bars of successive mixing elements are rotated by 90° and inserted between the tubes. The length L is preferably 0.5 to 4 D. A mixing element cut to length consists of full length bars (31, 41) and cut-off bars (31a, 41b). For a low pressure loss, the bars preferably have a smaller width b than the tube spacing t, and their installation becomes particularly simple when the maximum width is at most b=t−d (FIG. 2 and FIG. 3). Wider bars have recesses (FIG. 4) for the passage of the tubes and can also be easily installed in existing tube bundles if they are placed at a slight angle during installation. The contact line to the tubes is increased by wider bars. This has a beneficial effect on the strength of the structure and heat transfer when the tubes are connected to the bars. Of course, not all bars of an apparatus need to have the same width and shape. FIG. 9 shows an embodiment variant of an apparatus according to the disclosure without a housing in a perspective view with a tube bundle made up of 9 tubes and mixing elements of length L=D with 4 bars in cross-section. The bars in this variant are slightly wider than the free space between the rows of tubes and have a maximum width b>(t−d). The bars do not necessarily have to be cut to the length L but the bars of the bar layers can project into the following element as long as there is no conflict with the following bars rotated 90° or the mixing elements can be installed spaced apart as shown in FIG. 10. As such, frequent 90° rotation of the bar orientation would be desirable for cross mixing and heat transfer to the tubes. However, if the length L is too short, the transport over the entire cross-section becomes insufficient and the construction becomes more complex. On the other hand, if the number of 90° rotations is too low, the cross-mixing will be reduced.

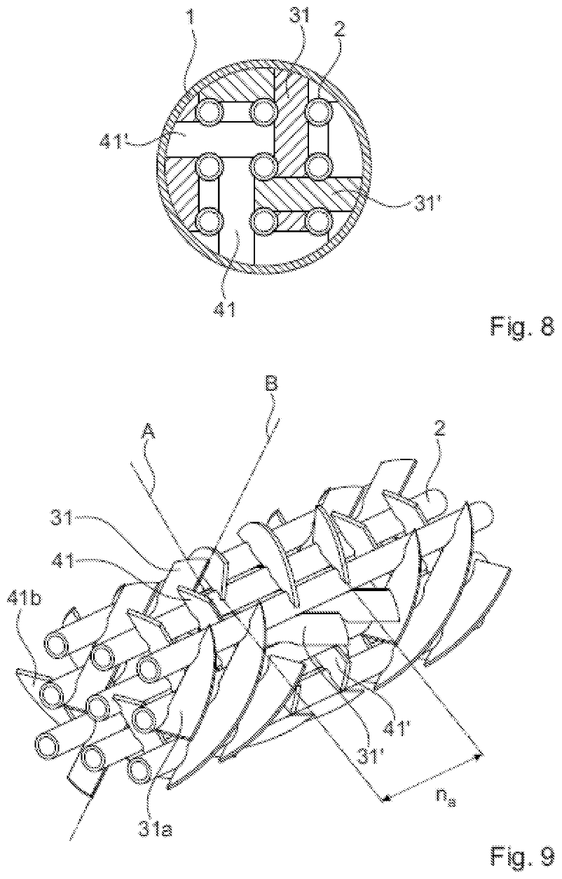

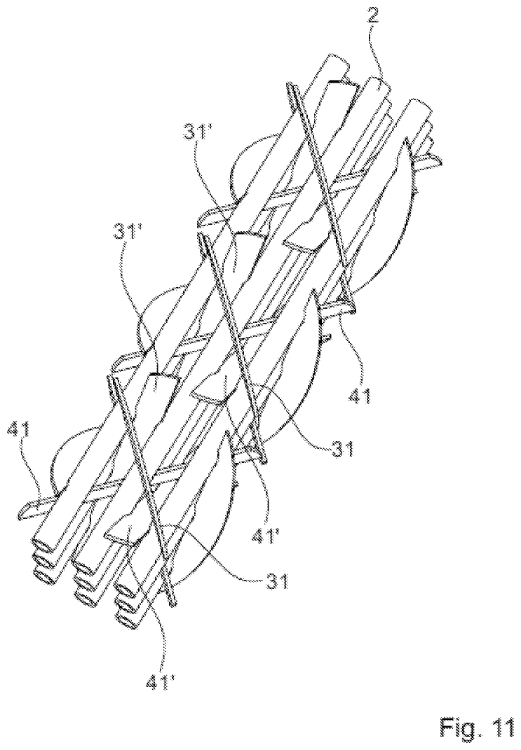

Surprisingly, the apparatus according to the disclosure offers a further, previously unknown type of bar arrangement, as shown in FIG. 8 and FIG. 11. Here the bars (31, 41) and the bars (31′, 41) rotated by 90° are inserted into one element interwoven between the tubes 2. The result is an element that mixes in two transverse directions at the same time. All subsequent elements have the same structure. The elements can be built in spaced apart or nested as much as possible. The typical 90° rotation of individual elements is no longer necessary, and a uniform structure is created.

All mixing elements within an apparatus according to the disclosure are preferably constructed in the same way and with the same bar spacing. However, for special tasks, such as locally dispersive mixing or locally increased heat transfer or mass transfer, it can be necessary to select a narrower or smaller axial distance m of the bars, the bar width b or the mixing element length L of individual mixing elements or mixing element groups within an apparatus.

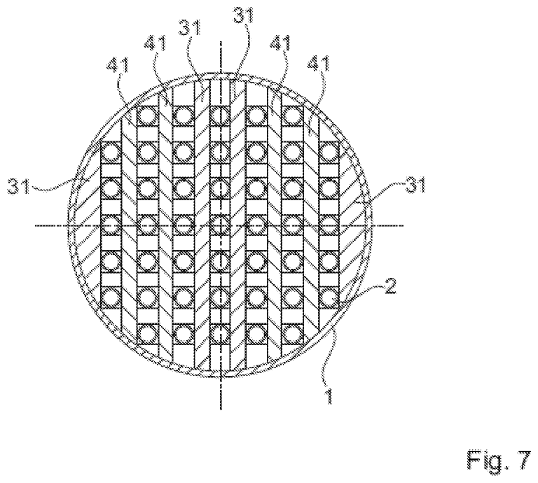

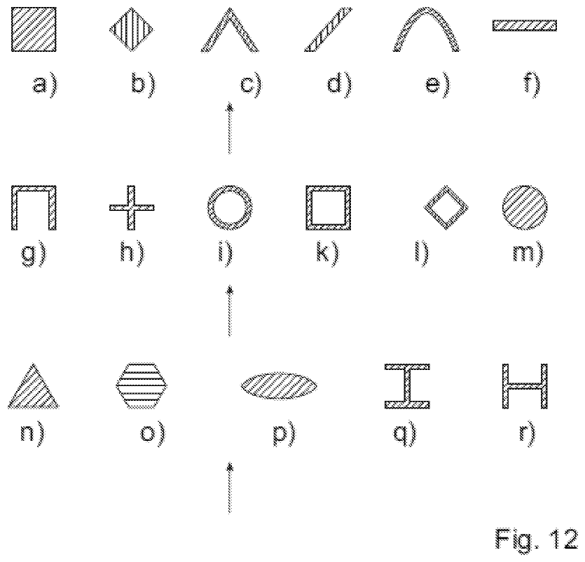

In order to achieve a high level of stability, the bars can be connected to the tubes at all or only some of the crossing points by welding, soldering or gluing. However, the bars do not necessarily have to be connected to the tubes if this is not desired for practical reasons, and groups of bars or layers of bars can be connected to each other by spacers and additional supports 5. Finally, the bars of a layer can also be connected by metal sheets and be inclined. Then the layers of bars can take the form of a corrugated sheet. In FIG. 2 straight bars of width b=t are shown as a variant, while in FIG. 4 the bars are wider in a further embodiment with recesses for the tubes. The width of the bars can be variable over their length, and the lateral boundaries can have a curved shape, as shown in FIG. 3 as a further variant. The maximum width is b=t. In FIGS. 2 to 8, the different angles of inclination of the crossing bars are indicated by the different direction of the hatching. For the sake of simplicity, the following refers to “tubes” or “tube bundles” in which a medium preferably flows for supplying or dissipating heat, although other elongated elements, even without a heat transfer medium, such as rods, profiles, heating rods, rod-shaped illuminants or tubes with a semi-permeable or porous wall can be used in their place if required. In addition, the applicability of the disclosure is not limited to metallic materials. The bars are preferably flat, plate-shaped profiles made of sheet metal or else U- or V-shaped profiles or tubes or hollow profiles or rods. Finally, the surface of the bars can also be structured. FIG. 12 shows a selection of possible profile shapes that can be used both as bars and as elongate elements.

Manufacturing the apparatus according to the disclosure for removable tube bundles is very simple. The bars or groups of bars can be inserted into the finished tube bundle. This is particularly true when the bar width is smaller than t−d everywhere and the bars are only connected to the tubes at the points that are accessible from the outside. But wider bars up to b=t can also be easily installed individually between the tubes of the finished tube bundle by appropriate inclination during installation. It is not until the bars are also to be connected to the tubes at points that are not accessible from the outside that it is necessary to insert the bars when assembling the tube bundle. Preferably, the bars are installed in U-shaped tube bundles because the apparatus can be expanded in this way and no thermal stresses can occur. In this case there are no tubes in the main axes of the case cross-section. The disadvantage of this arrangement is that correct counterflow to the heat transfer medium is not possible.

When building heat exchangers with fixed tube sheets and baffle plates, usually the baffle plates are installed first in the casing and then the tubes are pulled. This manufacturing process can also be used for the apparatuses according to the disclosure. For this purpose, the bars are only connected to a number of elongated elements, so that a stable structure is formed which can then, like the usual baffle plates, be built into the casing of the apparatus. Finally, the remaining tubes are pushed through the tube sheet and the X-structure at the designated locations. In this case, the tubes, with the exception of the supporting elements, are not connected to the bars. In addition to the manufacturing process mentioned, it is also possible to manufacture the entire installations and tubes or elongated elements as a monolithic component using a 3D printer, if the dimensions and the material make it possible. In another manufacturing variant, the installations are made from an easily meltable material in a 3D printer and covered with a mostly ceramic mass. Then the material inside the hardened mold is melted out and what remains is a mold that is filled with liquid metal (investment casting) or a hardening resin.

The number and size of tubes parallel to the longitudinal axis is determined by the required ratio of exchange area to volume of the apparatus or by the required specific heat transfer capacity (\dot{Q}/ΔT)=(kA/V), or if no heat is to be transferred, by the required support and stability of the bars and structure. The specific exchange areas (A/V) in reactors according to the disclosure are >50 m²/m³ and can be up to 400 m²/m³. The specific heat transfer capacity of the reactors according to the disclosure with highly viscous products can reach over 100 kW/m³K. For example, in the case of strongly exothermic polymerisation reactions, hot spots and runaway reactions occur if the specific heat transfer capacity of the reactor is not large enough. As a result, these reactions can only be controlled in tubular reactors with a small diameter. The reactors according to the disclosure correspond in terms of heat transfer capacity, mixing behaviour and residence time distribution, to tubular reactors with X-mixing elements with a tube diameter of 10 mm (A/V=400 m²/m³) to 80 mm (A/V=50 m²/m³). In contrast to these tubular reactors, in the reactors according to the disclosure the specific exchange area and the specific heat transfer capacity can be selected largely independently of the reactor or device volume. This makes the scale-up particularly easy. For example, polymerisation reactions are highly exothermic and at higher viscosities. In order that these can be reliably controlled with a narrow molecular weight distribution, apparatuses such as the apparatus according to the disclosure are necessary. Due to the very high specific heat transfer capacity and the narrow residence time spectrum, the polymerisation reactions can be controlled, in practice, isothermally at low temperature differences. Since the reaction and the heat transfer take place in a housing with permanent cross-mixing, a maldistribution cannot form. Results from pilot experiment with small tubular reactors with X-mixing elements are easily scalable up to industrial scale with the aid of the apparatus according to the disclosure with comparable mixing and residence time behaviour.

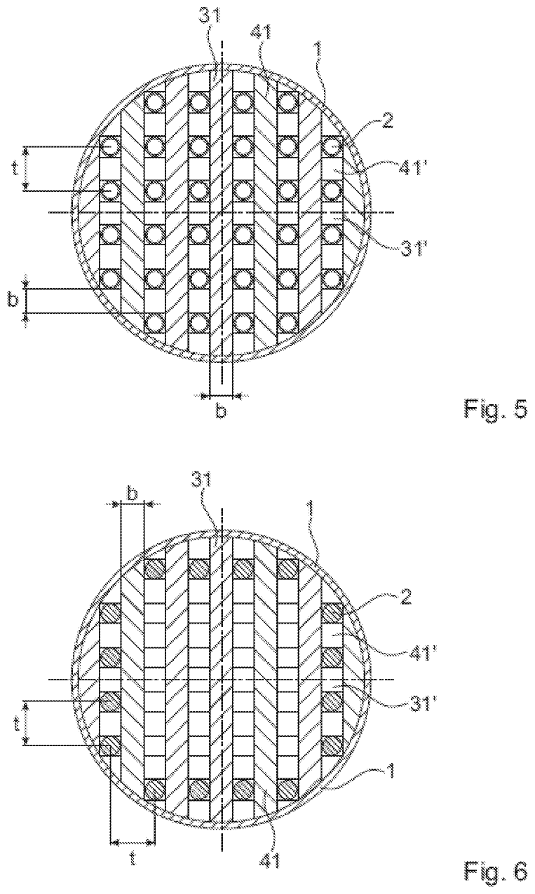

The tube spacing is preferably selected to be uniform over the entire cross-section. With a square tube spacing, the structure is particularly simple because the components of all mixing elements are the same. It is also possible that the spacings in both transverse directions and the bar widths of the groups rotated by 90° are different or differ locally. However, it is also possible to choose the spacing locally differently, or to omit individual or groups of tubes, or to use tubes or elongated elements with other properties such as light elements or elements with semi-permeable or porous walls, or simply tubes or rods without heat transfer medium or other elongated profiles to reinforce the structure at the intended tube locations instead of tubes for heat exchange, if the required heat transfer capacity makes it possible. The number of bars n_{b} in the projection on the cross-sectional area corresponds to n_{b}=rₘ+1 wherein rₘ represents the number of tubes in the tube row at or near the cross-section axis. In contrast to the known X-mixers, the number of bars increases with an increasing number of tubes and/or housing diameters. Surprisingly, it has been shown that the number of bars in the transverse direction has only a small influence on the pressure loss. The mixing effect is also very good if the number of bars is at least n_{b}=4 and hardly increases more than n_{b}=8. FIG. 5 shows a view in the direction of flow for an embodiment variant of an apparatus according to the disclosure with 32 tubes and 7 bars over the cross-section.

In many practical applications of the apparatuses according to the disclosure, the flowing medium has to only be mixed or dispersed statically, without heat being supplied or dissipated at the same time, or without the product having to be tempered. Tube positions can then be partially disengaged and/or the tubes are completely or partially replaced by full profiles that serve as reinforcement for the structure. This creates static mixers with very high stability against the flow forces, such as those that occur during extrusion or injection moulding of tough plastic melts.

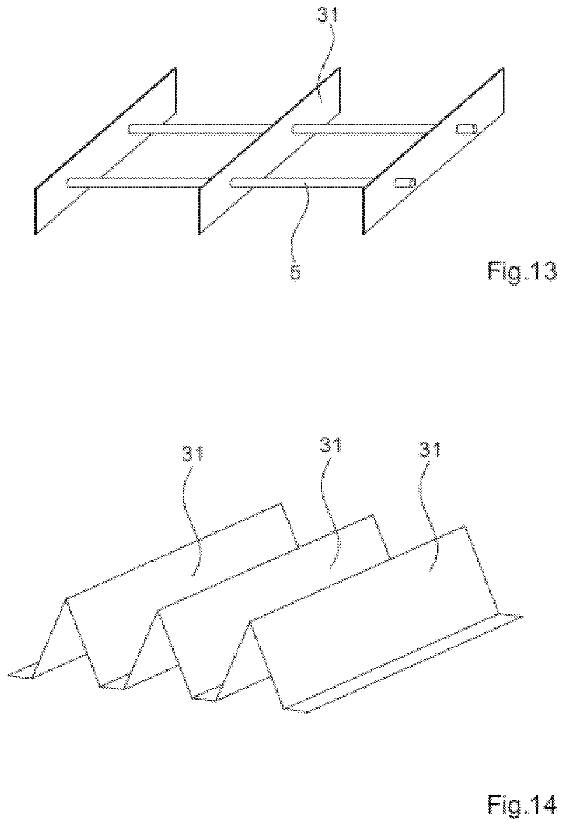

FIG. 6 shows a variant like FIG. 5, in which not all possible tube locations are engaged and in which some tubes are replaced by full rods or profiles. FIG. 12 shows a selection of possible shapes of elongate elements. The selection is not complete. These elongate elements can be installed both axially instead of tubes 2 and inclined with respect thereto as alternative forms of bars (31, 41). Axially consecutive bars 31 can be connected by auxiliary elements 5 to form a layer of bars and inserted between the tubes, as shown in FIG. 13. Inclined sheets are also possible as a connection and the layer of bars becomes a corrugated sheet-like structure as shown in FIG. 14.

The intersecting bars or profiles, which are inclined with respect to the housing axis, ensure intensive transverse mixing and transverse flow and improve the heat and mass transfer to the tubes. The vertical distance m between the bars that follow in the direction of flow is a determining measure of the pressure drop in the tube bundle structure according to the disclosure, because it significantly influences the wetted surfaces of the installations in the reactor. The distance m should therefore be as large as possible, preferably 0.2 to 0.4 D, if only good cross-mixing with little or no heat exchange is required. It is expected that a more frequent crossing of the tubes with the bars and a frequent rotation of the bar direction is favourable for the heat transfer to the tubes. In laminar flow, it was discovered that the heat transfer coefficient or mass transfer to the tubes increases greatly when the ratio is m/d<4. With a smaller distance m, however, the pressure loss of the apparatus also increases. The optimal distance m or the optimal diameter d of the inner tubes and the optimal tube spacing t therefore depend on the specific requirements of the application.

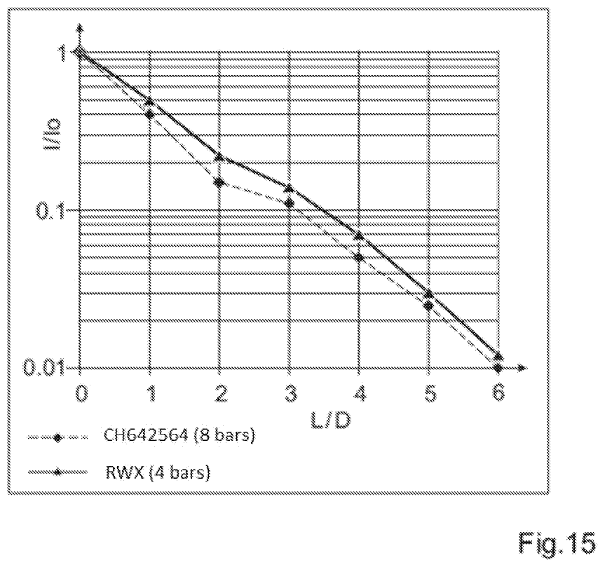

In a mixing trial with hardening polyester resin, an apparatus according to the disclosure with a bundle of 9 tubes and 4 each was inserted and crossed bars were carried out based on the projection in the direction of flow of a cross-section according to FIG. 9. The element length L up to a 90° rotation was 1 D and the maximum width of the bars b was 60% of the tube spacing t. The result was compared with a prior art X-mixer according to CH 642 564 with 8 bars based on the projection in direction of flow of a cross-section and the same axial bar distance m of the bars, the same element length and the same angle of inclination of the bars. The hardened mixer rods were each cut open after 1 D length and the maximum thickness l of a layer was measured out as a mixing quality measure and compared with the initial thickness lₒ. This measurement method is very simple and efficient for demonstrating the mixing process and the mixing quality in static mixers with laminar flow, especially in the initial mixing area. The result of the mixing trial is shown in FIG. 15. Surprisingly, almost the same maximum layer thickness (mixing quality) is achieved in the apparatus according to the disclosure with only 4 bars as in the static mixer according to the state of the art with 8 bars! The wetted bar surface of the apparatus according to the disclosure is only about 60% compared to the design according to the prior art. Therefore, it can be expected that the pressure loss in laminar flow also decreases in almost the same ratio, since the axially aligned tubes hardly contribute to the pressure loss. The experiment shows that the apparatus according to the disclosure also achieves an excellent mixing effect with low pressure loss, even if the bar width is significantly smaller than the tube spacing or even if the bars are pushed between the tubes without recesses (maximum bar width b=t−d).

To prove the expected narrow residence time distribution of the apparatus according to the disclosure, CFD flow calculations were carried out to simulate the residence time distribution with the apparatus described above and compared with the known X-mixer. The calculations confirmed that the residence time behaviour of the apparatuses according to the disclosure is, as expected, comparable to the known X-structure. As a result, static reactors with an extraordinarily large heat transfer capacity, good transverse mixing and almost ideal plug flow can be produced with the apparatus according to the disclosure.

The application of the apparatus according to the disclosure is not only limited to the laminar flow range. It is known that the X-structure is very well suited for dispersing liquids or gases in turbulent flow in low-viscosity media. This apparatus is therefore also suitable for low-viscosity media for reactions with a high degree of heat generation or also for bio reactors. If the tubes are replaced by rod-shaped light generators or conductors also for photosynthesis. In the case of vertical installation, a catalyst carrier can also be easily filled into the housing for carrying out heterogeneous, catalytic reactions with higher heat of reaction in a fixed bed or in a fluidised bed.

The inventive apparatus is preferably used as a mixer-heat exchanger with high transverse and low axial back-mixing for

as a heat exchanger for laminar flow in general

heating or cooling polymer solutions or melts

product heater with partial degassing before degassing chambers

cooling of viscous products

heating sensitive or reactive viscous products

reactors, in particular polymerisation reactor

gas-liquid reactor

bio reactor with photosynthesis

reactor for heterogeneous catalysis with fixed bed or fluidised bed

or even without a heat transfer medium as a static mixer with a stable structure and low pressure loss, preferably for viscous products. Static mixers for plastic melts have to withstand very high flow forces and always need temperature control to keep the operating temperature in the desired range. This is why these mixers are equipped with a double-cased tube configured to be heated. The mixing elements often have to be supported on the housing wall so that they can withstand the flow forces. The mixing elements can then no longer be removed and the weld testing required by the pressure vessel regulations is also not always possible. With the apparatus according to the disclosure, an X-mixer is provided for this and similar applications, which is easy to heat, very stable and expandable. A very expensive double-cased tube is no longer required and is replaced by U-shaped tube coils through which a heat transfer medium flows. If necessary, further elongated profiles at the tube locations perform the necessary reinforcement of the structure. The mixer according to the disclosure can also be heated quickly to the operating temperature, since no high stresses are to be expected in the housing, as is the case with a double-cased tube.

1. An apparatus for supplying or dissipating heat, for carrying out reactions and for mixing and dispersing flowing media in a housing with an internal diameter D, through the longitudinal axis of which a main flow direction for a liquid, gaseous or multi-phase product flow (I) is determined, with installations, wherein the installations include a bundle of tubes with an outer diameter d or other elongated elements and between the tubes or other elongated elements at least one bar of a first arrangement is installed and this at least one bar is inclined by an angle α which=an angle between 30-60° to the longitudinal axis of the housing and, inserted crosswise thereto, at least one second bar of a second arrangement installed with the same angle of inclination but opposite sign, and wherein the bars have a width b and this width is smaller than or equal to a spacing t of the bundle of tubes with outer diameter d or other elongated elements, and in that the bars do not touch.

2. The apparatus according to claim 1, wherein bars following one another in the axial direction form a layer of bars between the tubes or other elongated elements and the bars of a layer of bars are parallel and have a distance m, and in that the layers of bars are installed between the tubes after a number of bars or a length L rotated by 90°.

3. The apparatus according to claim 1, wherein a first layer of bars is adjacent to a second layer of bars installed crosswise and that there is a tube or row of tubes in between, and the bars do not touch each other.

4. The apparatus according to claim 1, wherein there are distances between the adjacent bars transversely to the main direction of flow and that the maximum width b of the bars is less than 85% of the tube spacing t.

5. The apparatus according to claim 1, wherein the bars fit between the tubes of the bundle of tubes with outer diameter d or other elongated elements without recesses and have a maximum width b=t−d.

6. The apparatus according to claim 1, wherein the bars are aligned in the transverse direction in such a way that the bars respectively lie in crossing planes A, B.

7. The apparatus according to claim 1, wherein the axial distance m of the bars is 0.2 to 0.4 D at least in one bar position.

8. The apparatus according to claim 1, wherein the axial spacing m of the bars is <4 d at least in one bar position.

9. The apparatus according to claim 2, wherein groups of layers of bars form mixing elements with an axial length L and that the layers of bars of successive mixing elements are rotated by 90° and inserted between the tubes, and that the length L of the mixing elements is 0.5 to 4 D.

10. The apparatus according to claim 2, wherein the intersecting webs of a first group are interwoven with the intersecting webs of a second group rotated through 90° to form a mixing element which mixes in two transverse directions.

11. The apparatus according to claim 1, wherein at least some of the elongate elements are tubes with an inlet and outlet apparatus for a liquid, gaseous or vaporous heat transfer medium and that this flows in co-current or counter-current to the product flow flows outside the tubes.

12. The apparatus according to claim 1, wherein at least part of the elongate elements are electric heating rods or electric heating coils.

13. The apparatus according to claim 1, wherein at least part of the elongate elements have a porous or semi-permeable wall for an exchange process.

14. The apparatus according to claim 1, wherein at least part of the elongate elements is fixed to the bars or forms a monolithic part with the bars.

15. The apparatus according to claim 1, wherein the bars of at least one layer of bars are inclined towards each other and are connected to each other by auxiliary elements or metal sheets and form a corrugated sheet-like layer of bars.

16. The apparatus according to claim 1 groups of layers of bars are connected to each other transversely or longitudinally by auxiliary elements.

17. The apparatus according to claim 1, wherein the ratio of the surface area of the bundle of tubes with outer diameter d or other elongated elements to the empty volume of the apparatus or reactor is at least 50 m²/m³.

18. The apparatus according to claim 1, wherein at least some of the tubes or elongate elements are luminous elements or elements with semi-permeable or porous walls or tubes or rods without heat transfer medium or other elongate profiles for reinforcing the structure at the intended locations of the bundle of tubes with outer diameter d or other elongated elements.

19. The apparatus according to claim 1, wherein at least some of the spacing t provided for the tubes of the bundle of tubes with outer diameter d or other elongated elements are disengaged.

20. A method for carrying out heterogeneous, catalytic reactions or for mass transfer in a flowing medium in an apparatus according to claim 1, wherein the product space (I) around the tubes of the bundle of tubes with outer diameter d or other elongated elements is filled with a solid or fluidised bed of catalyst supports or ion exchange resins.

21. The apparatus according to claim 1, wherein the at least one bar of a first arrangement is a plate-shaped bar and the at least one second bar of a second arrangement is a plate-shaped bar.

22. The apparatus according to claim 1, wherein the installations include a bundle of tubes with outer diameter d or other elongated elements are aligned parallel to the longitudinal axis of the housing and have a square spacing t.

23. The apparatus according to claim 1, wherein the at least one second bar of a second arrangement has the same angle of inclination but with the opposite sign as the at least one bar of a first arrangement.

24. The method according to claim 20, wherein the flowing medium is a highly viscous solution or melt with a single-phase or multi-phase state of aggregation and the ratio of the surface area of the bundle of tubes with outer diameter d or other elongated elements to the empty volume of the apparatus or reactor is at least 50 m²/m³.
